(19) United States
(12) Patent Application Publication
(10) Pub. No.: US 2024/0403950 A1
(43) Pub. Date: Dec. 5, 2024

(54) BIDDING METHOD AND SYSTEM

(71) Applicant: Naif Abdullah Al Humidan, Taif (SA)

(72) Inventor: Naif Abdullah Al Humidan, Taif (SA)

(21) Appl. No.: 18/806,684

(22) Filed: Aug. 15, 2024

Related U.S. Application Data
(63) Continuation-in-part of application No. 17/271,916, filed on Feb. 26, 2021, now abandoned.

(51) Int. Cl. G06Q 30/08; G06Q 20/40; G06Q 30/0601

(52) U.S. Cl. CPC G06Q 30/08; G06Q 20/407; G06Q 30/0641

(57) ABSTRACT

A novel online bidding system and method allows the seller to list goods or services for sale or rent at a full price for immediate trade and at a discounted price. If at least one bidder accepts a discounted price and makes an escrow deposit, the system initiates and completes an online auction to determine the highest bidder and complete the transaction with the highest bidder. If no other bidders are present, the first bidder receives the item or service at a discounted price. The bidding system has multiple advantages for the seller, the buyer, and the intermediary party, such as the auction owner.

### CROSS-REFERENCE DATA

This U.S. patent application is a continuation-in-part of the co-pending U.S. patent application Ser. No. 17/271,916 filed on Feb. 26, 2021, with the same title and by the same inventor, now abandoned, which in turn is a U.S. national phase application under 35 U.S.C. 371 of the international patent application No. PCT/US2019/050070 filed on Sep. 6, 2019, which, in turn, claims a priority date benefit from the U.S. Provisional Patent Application No. 62/765,666, entitled IMPROVED BIDDING PROCESS, filed on Sep. 6, 2018, by the same inventor. The PCT application also claims a priority date benefit from the U.S. Provisional Patent Application No. 62/766,744, entitled IMPROVED BIDDING PROCESS, filed on Nov. 1, 2018 by the same inventor. All of these patent documents are hereby incorporated by reference in their respective entireties.

### BACKGROUND

An auction is a process of buying and selling/renting goods or services by offering them up for bid, taking bids, and then selling the item to the highest bidder. The open ascending price auction may be the most common form of auction in use today. Participants bid openly against one another, with each subsequent bid required to be higher than the previous bid. Auctions are most associated with the sale of antiques, rare collectibles, paintings, and expensive wines. Auctions are also used for commodities, livestock, radio spectrum, real estate, and used cars. The primary objective of an auction is to achieve the highest possible price through transparent and competitive bidding. The term “auction” in this description refers broadly to any mechanism or set of trading rules for exchange in which any item of goods or services is traded through a process generally described above.

The present invention is also concerned with reversed auctions. A Reverse auction is a type of auction in which the roles of the buyer and the seller are reversed, with the primary objective to drive purchase prices downward. While ordinary auctions provide suppliers the opportunity to find the best price among interested buyers, reverse auctions give buyers a chance to find the lowest-price supplier. During a reverse auction, suppliers may submit multiple offers, usually as a response to competing suppliers' offers, bidding down the price of a good or service to the lowest price they are willing to receive.

With the advent of online marketplaces, the ability of sellers to find qualified buyers have greatly expanded, which has contributed to the popularity of these platforms.

Websites like Craigslist™, whose users do trading based on traditional sales methods, encounter several challenges. First is the common issue of monetization. They can't force local traders to make payments through their platforms (from which they can take a percentage of the deal) as local traders can simply make deals offsite. Charging for listing upfront is not desirable and can cause sellers to drive away from listing as fees are often nonrefundable even if the item doesn't sell. Furthermore, traders on these websites who use traditional sale method face the challenge of negotiation. Deals often don't go in the best interest of sellers or buyers as they lack any bidding component leaving sellers wondering what the true market value of the item is. Sellers have to deal with the back-and-forth process of haggling with each potential buyer separately, and often end up agreeing to a price they had no intention of dropping down to.

Auction websites such eBay™ attempt to resolve the negotiation issue of the traditional sale method by providing sellers the option to use a regular auction method in which multiple bidders engage in driving up an item's price to reach its true market value. However, regular auction methods are often not effective and lack activity from buyers. Listings are mostly unattractive and their auction time often ends with items unsold, in which case owners have to relist the items, and may pay additional fees. Another common challenge in regular online auctions is the problem of shill bidding. This is when sellers or their associates place bids on their own items to artificially increase price.

Thus, there is still a need for a more flexible and improved vehicle for negotiating and bidding, one that can overcome the shortcomings of both traditional sale and regular auction methods, and can provide a better experience for buyers, sellers and intermediaries.

### SUMMARY

An exemplary embodiment relates to a bidding process for selling or renting an item or service to the highest bidder. The term “seller” includes a party that sells or rents various goods or sells various services. The term “buyer” includes a party that buys or rents goods or services from the seller. The novel bidding method may be implemented by using a computerized auction system, and may include the following steps:
a. operating a seller's user interface to create a listing for a sale or rent of goods or services. The listing may include a discounted price set by the seller or a request for a discounted price from a first buyer. There are two conditions associated with the discounted price:
   (i) an obligation by the first buyer to undergo an auction for the listed goods or services, and
   (ii) an obligation by the seller to sell or rent the listed goods or services to a highest bidder at the auction and at the highest price or to sell or rent thereof to the first buyer and at the discounted price if no other buyers are present,
b. operating at least one buyer's user interface to present the listing for the sale or rent of goods or services of step (a),
c. in response to at least the first buyer accepting the discounted price for the listed goods or services through the buyer's user interface, operate the computerized auction system to automatically initiate an automated auction with the first buyer and other buyers if present,
d. operating the computerized auction system to automatically complete the auction to determine the highest bidder and the highest price, and
e. operating the computerized auction system to automatically complete the transaction after the auction of step (d) is complete to sell or rent the listed goods or services to the highest bidder and at the highest price.

One key advantage of the novel method is that upon at least the first buyer accepting the discounted price, the transaction is guaranteed to be completed at least at the discounted price or higher. This eliminates a large portion of unsold items typically associated with the previous methods of conducting online auctions.

In other embodiments, the method may include a step of providing by the seller a “buy or rent now” price, wherein the “buy or rent now” price is higher than the discounted price, and wherein the method further comprises a step (f) of operating the computerized auction system to automatically complete the transaction immediately upon the first buyer accepting the “buy or rent now” price without the auction.

Furthermore, the method may include a step of operating the computerized auction system to automatically accept a deposit from each buyer prior to initiating the auction and/or including the buyer in the auction for the listed goods and services. The system of the invention may be configured to automatically refund the deposit to all buyers other than the first buyer or the highest bidder.

The discounted price may be established by the seller, or proposed by the buyer followed by a negotiation process which may result in an agreement between both parties as to the value of the discounted price. The negotiation process may include a step of the first buyer proposing a first discounted price, followed by a step of the seller agreeing thereto or counteroffering a second discounted price, wherein the second discounted price is higher than the first discounted price.

In further embodiments, the discounted price may include a plurality of discounted prices corresponding to a plurality of auction durations. In some embodiments, the discounted prices of the plurality of discounted prices may be progressively reduced as the corresponding auction durations increase.

In other embodiments, the seller interface may be configured to accept the listing of step (a) and cause the listing to be available to at least the first buyer only after the seller confirms irrevocable acceptance of the obligation of the seller specified in step (a)(ii). Furthermore, the buyer interface may be configured to accept the first buyer's acceptance of the discounted price for the listed goods or services in step (c) only after the buyer confirms irrevocable acceptance of the obligation of the buyer specified in step (a)(i).

The computerized auction system of the invention may be operatively connected (via a wired or wireless connection) to the buyer interface and the seller interface via the Internet or another computer network, thereby facilitating the completion of steps (a) through (e) without a need for the buyer and the seller to be in one location.

The present invention also describes a reverse auction system and method. In one embodiment, the online bidding method may be implemented by using a computerized reverse auction system, and include the following steps:
(a) operating a buyer's user interface to create a listing for purchase or rent of goods or services, the listing to include a discounted price set by the buyer or a request for a discounted price from a first seller, wherein the discounted price is conditioned by:
   i. an obligation by the first seller to undergo a reverse auction for the listed goods or services,
   ii. an obligation by the buyer to purchase or rent the listed goods or services from the lowest bidder at the auction and at the lowest price,
(b) operating at least one seller's user interface to present the listing for the purchase or rent of goods or services of step (a),
(c) in response to at least the first seller accepting the discounted price for the listed goods or services through the seller's user interface, operate the computerized reverse auction system to automatically initiate an automated reverse auction with the first seller and other sellers if present, or to complete the transaction with the first seller at the discounted price if no other sellers are present,
(d) operating the computerized reverse auction system to automatically complete the reverse auction to determine the lowest bidder and the lowest price, and
(e) operating the computerized reverse auction system to automatically complete the transaction after the reverse auction of step (d) is complete to purchase or rent the listed goods or services from the lowest bidder and at the lowest price.

The advantage of the novel bidding method is that upon at least the first seller accepting the discounted price, the transaction is guaranteed to be completed at least at the discounted price or lower, thereby reducing the number of unfulfilled listings.

### BRIEF DESCRIPTION OF THE DRAWINGS

FIG. 1 is an exemplary embodiment of a characteristic system that may be used to implement the invention.

FIG. 2 is an exemplary process diagram of the inventive auction process.

The use of the same symbols in different drawings typically indicates similar or identical items unless context dictates otherwise.

### DETAILED DESCRIPTION OF THE INVENTION

The disclosed exemplary embodiments provide an improved bidding process for local traders such as those who list their real estate properties, cars, etc. on websites like Craigslist for sale or rent. The process overcomes several common challenges often faced by sellers, buyers, and intermediaries (websites).

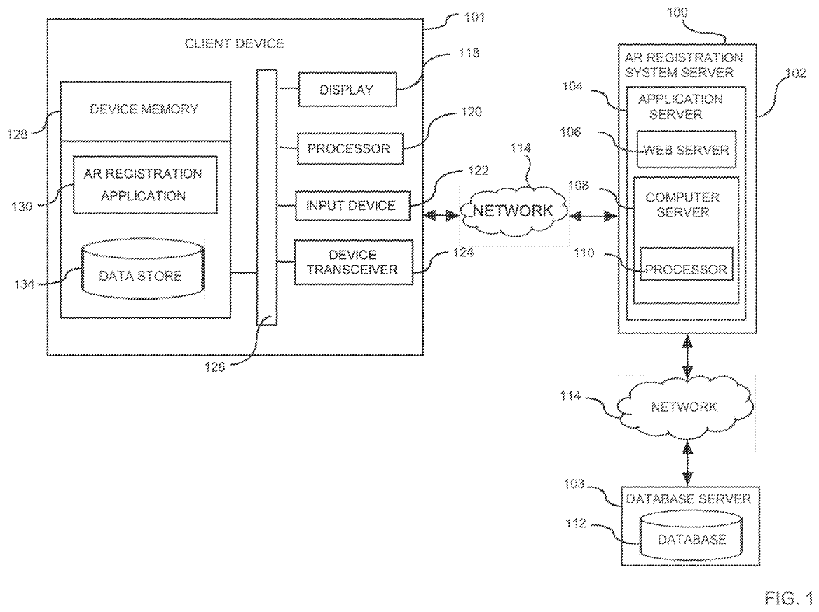

Referring now to FIG. 1, the general architecture of a client-server application system 100 that operates in accordance with exemplary embodiments to enable the improved bidding process described, is depicted. The online system depicted in FIG. 1 is generalized in nature and is only an example of a system on which the improved bidding process may be carried out. In an exemplary embodiment, system 100 is implemented in multi-tier or n-tier architecture with one or more client devices 101 residing at the client tier, one or more servers 102 in the middle of server application tier and one or more database servers 103 residing in the database tier. In the above variant of three-tier architecture the client, the first tier, may have to only perform the user interface i.e., validate inputs; in which case the middle tier holds all the backend logic and does data processing while the data server, the third tier, performs data validation and controls the database access.

One or more client devices 101 are connected to system server 102 via network 114. The system server 102 communicates with the client devices 101 over the network 114 to present a user interface or graphical user interface (GUI) for the service system 100 of the present invention. The user interface of the service system 100 of the present invention can be presented through a web browser or through a mobile application communicating with the system server 102 and is used for displaying, entering, publishing, and/or managing data required for the service. As used herein, the term “network” generally refers to any collection of distinct networks working together to appear as a single network to a user. The term also refers to the so-called worldwide “network of networks” or the Internet in which several elements of the system of the invention are connected to each other using the Internet protocol (IP) and other similar protocols. As described herein, the exemplary public network 114 of FIG. 1 is for descriptive purposes only and it may be wired or wireless.

Although the description may refer to terms commonly used in describing public networks such as the Internet, the description and concepts equally apply to other public and private computer networks, including systems having architectures dissimilar to that shown in FIG. 1. The inventive idea of the present invention is applicable to all existing cellular network topologies or respective communication standards, such as GSM, UNITS/HSPA, LTE, and the like. Since the system may operate via the Internet, various elements of the system may not be at the same location. As a result, the buyer and the seller are not required to be at the same physical location either.

With respect to the present description, the system server 102 may include any service that relies on a database system that is accessible over a network, in which various elements of hardware and software of the database system may be shared by one or more users of the system 100. To this end, the users of the client device 101, from which a request or instruction is received over a network 114, may include any individual customer, a governmental or non-governmental organization, a group etc. The GUI or user interface provided by the system server 102 on the client devices 101 through a web browser or mobile app may be utilized by the users for utilizing service system 100.

The components appearing in system server 102 refer to an exemplary combination of those components that would need to be assembled to create the infrastructure to provide the tools and services contemplated by the present invention. As will be apparent to one skilled in the relevant art(s), all of the components “inside” of system server 102 may be connected and may communicate via a wide or local area network (WAN or LAN).

The system server 102 includes an application server or executing unit 104. The application server or executing unit 104 comprises a web server 106 and a computer server 108 that serves as the application layer of the present invention. The Web server 106 is a system that sends out Web pages containing electronic data files in response to Hypertext Transfer Protocol (HTTP) requests from remote browsers (i.e. browsers installed in the client devices 101) or in response to similar requests made through a mobile app or mobile application of the present invention installed on a client device 101. The web server 106 can communicate with the mobile app of the present invention and/or with a web browser installed on a client device 101 to provide the user interface required for the service.

The computer server 108 may include a processor 110, a random-access memory (RAM) (not shown in figures) for temporary storage of information, and a read-only memory (ROM) (not shown in figures) for permanent storage of information. Computer server 108 may be generally controlled and coordinated by operating system software. The operating system controls the allocation of system resources and performs tasks such as processing, scheduling, memory management, networking, and I/O services, among (other) things. Thus, the operating system resides in system memory and, on being executed by the CPU, coordinates the operation of the other elements of AR server 102.

Although the description of the computer server 108 may refer to terms commonly used in describing computer servers, the description and concepts equally apply to other processing systems, including systems having architectures dissimilar to that shown in FIG. 1.

The database tier is the source of data where at least one database server 103 generally interfaces multiple databases 112. Those databases are frequently updated by their users and administrators most often through a combination of private and public networks 114 including the Internet. It would be obvious to any person skilled in the art that, although described herein as the data being stored in a single database, different separate databases can also store the various data and files of multiple users.

A mobile application, or “app,” is a computer program that may be downloaded and installed in client device 101 using methods known in the art. Hereinafter, the mobile app 130 is referred to as app 130. App 130, custom-built for the present invention, enables one or more persons to do various tasks related to live, in-person translation services using the system of the present invention. The activities related to the service of the present invention can also be performed using the user interface (or GUI) presented through a client device-based web browser. In embodiments, GUI may be optimized for smaller screens (e.g., smartphones and even smartwatches).

Hereinafter, the term “user interface” is used to refer to both the app user interface and the web browser user interface of the present invention. Examples of client device 101 may include, but are not limited to, mobile devices, tablets, hand-held or laptop devices, smartphones, smartwatches, desktop computers, wearable devices, augmented reality glasses, virtual reality headsets, or any other similar devices.

As illustrated in FIG. 1, the client device 101 may include various electronic components known in the art for this type of device. In this embodiment, the client device 101 may include a device display 118, a computer processor 120, a user input device 122 (e.g., touch screen, keyboard, microphone, and/or another form of an input device known in the art), a device transceiver 124 for communication, device memory 128, the AR app 130 operably installed in the computer memory 128, a local data store 134 also installed in the device memory 128, and a data bus 126 interconnecting the aforementioned components. For purposes of this application, the term “transceiver” is defined to include any form of transmitter and/or receiver known in the art, for cellular, WIFI, radio, and/or other form of wireless or wired communication known in the art.

Obviously, these elements may vary or may include alternatives known in the art, and such alternative embodiments should be considered within the scope of the claimed invention. In particular, the system of the invention may leverage specific hardware architecture (e.g., multi-tier architecture, network configurations) to optimize auction speed and reduce latency, a critical factor in these systems. For example, high-speed processors, FPGAs, or GPUs that handle complex computations or secure deposits efficiently. Furthermore, the computerized system of the invention may incorporate artificial intelligence elements, neural networks, and other advanced technologies for a variety of useful purposes. Examples of such purposes may include bid value prediction, dynamic auction adjustments, improving the system's response and effectiveness, improved security measures, like encryption or secure escrow, fraud detection, and using machine learning to prevent shill bidding or other fraudulent activities.

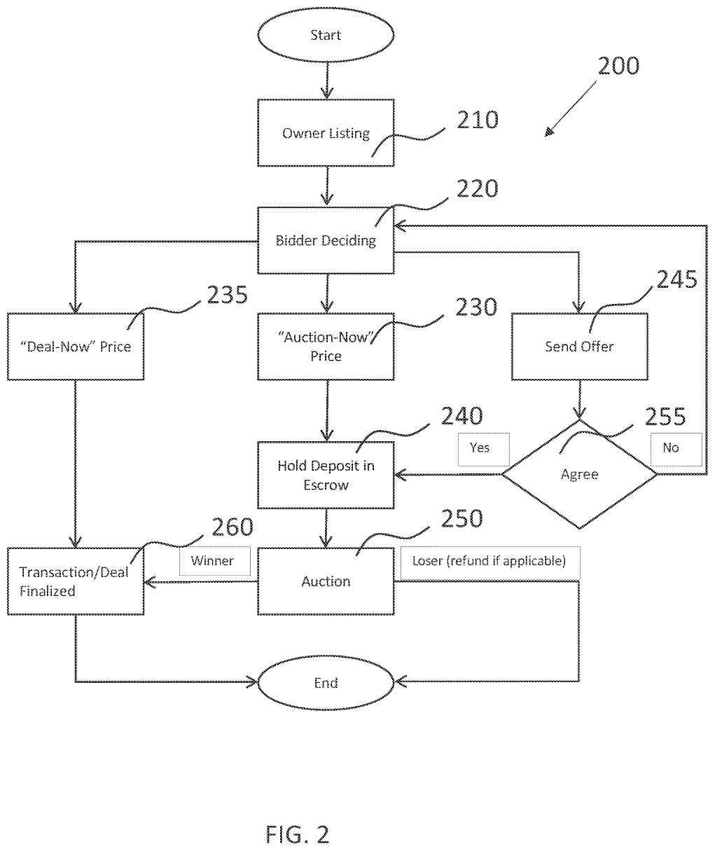

Referring now to FIG. 2, an exemplary forward bidding process 200 is depicted. In broad terms, the steps of the method include:
a. operating a seller's user interface to create a listing for a sale or rent of goods or services—process 210. The listing may include a discounted price set by the seller, also referred to as an “Auction Now” price 230. Two conditions are associated with the discounted price:
   i. an obligation by the first buyer to undergo an auction for the listed goods or services, and
   ii. an obligation by the seller to sell or rent the listed goods or services to the highest bidder at the auction and at the highest price or to sell or rent thereof to the first buyer and at the discounted price if no other buyers are present,
b. operating at least one buyer's user interface to present the listing for the sale or rent of goods or services of step (a)—process 220,
c. in response to at least the first buyer accepting the discounted price for the listed goods or services through the buyer's user interface (process 230), operate the computerized auction system to automatically initiate an automated auction with the first buyer and other buyers if present—process 250,
d. operating the computerized auction system to automatically complete the auction to determine the highest bidder and the highest price. The computerized auction system in this case runs a regular, quick auction using the accepted offer of a discounted price as the opening bid. This provides a final chance to any other interested bidders who can afford and want to bid more money to win the deal. In some embodiments, the bidders may not be able to bid in the auction until they pay a deposit into the escrow. During the auction, bidders, including the first bidder of the accepted discounted price, may bid against each other without the ability to retract a bid once it's placed. At the end of the auction, the highest bidder is declared a winner and then proceeds to finalize the transaction with the seller and complete the deal (process 260). Failing to do that, the bidder would risk the deposit being forfeited. Losing bidders' deposits are refunded to them automatically.
e. operating the computerized auction system to automatically complete the transaction after the auction of step (d) is complete to sell or rent the listed goods or services to the highest bidder and at the highest price—process 260.

Of note is that in steps (c) and (d) the first bidder can be regarded as the opening bidder in the auction, and as the highest bidder in the auction if no other bidders are participating during the auction.

In other embodiments, the method may include a step of providing the seller a “buy or rent now” price (referred to as a “Deal Now” price 235, wherein the “buy or rent now” price is higher than the discounted price, and wherein the method further comprising a step (f) of operating the computerized auction system to automatically complete the transaction immediately (process 260) upon the first buyer accepting the “buy or rent now” price without the auction.

Furthermore, the method may include a step of operating the computerized auction system to automatically accept a deposit from each buyer prior to initiating the auction and/or including the buyer in the auction for the listed goods and services. Such deposit may be held in an escrow—process 240.

In embodiments, escrow transactions may be facilitated using smart contracts and digital wallets on a blockchain to create the automatic transfer of funds into an escrow account with enhanced security, transparency, and efficiency. A smart contract is a self-executing contract with the terms of the agreement directly written into code. When a pre-defined condition is met—such as determining the highest bidder in an auction—the smart contract triggers the transfer of funds from the respective buyer's digital wallet to the corresponding escrow account. This account may be hosted on the blockchain, and act as a neutral holding space, ensuring that neither party can access the funds until all contractual obligations are satisfied. Once the conditions set within the smart contract are verified on the blockchain, the funds may be automatically released from escrow to the designated recipient. This process eliminates the need for intermediaries, reduces transaction costs, and minimizes the risk of fraud by relying on the immutability and decentralized nature of blockchain technology.

The deposit can be a fixed amount or a percentage of the bid price. The amount of the deposit may also depend on the condition of the marketplace and the participant's degree of trustworthiness. It can be set as low as 0% (waived) with cases when the risk of fraud is minimal, for example, private professional markets operated exclusively for licensed, registered participants in good standing. The system of the invention may be configured to automatically refund the deposit to all buyers other than the first buyer or the highest bidder.

The discounted price may be established by the seller or proposed by the buyer followed by a negotiation process 245 which may result in an agreement 255 between both parties as to the value of the discounted price. The negotiation process may include a step of the first buyer proposing a first discounted price, followed by a step of the seller agreeing thereto or counteroffering a second discounted price, wherein the second discounted price is higher than the first discounted price.

In further embodiments, the discounted price may include a plurality of discounted prices corresponding to a plurality of auction durations. In some embodiments, the discounted prices of the plurality of discounted prices may be progressively reduced as the corresponding auction durations increase.

In other embodiments, the seller interface may be configured to accept the listing of step (a) and cause the listing to be available to at least the first buyer only after the seller confirms via the seller's interface the irrevocable acceptance of the obligation of the seller specified in step (a)(ii). Furthermore, the buyer interface may be configured to accept the first buyer's acceptance of the discounted price for the listed goods or services in step (c) only after the buyer confirms irrevocable acceptance of the obligation of the buyer specified in step (a)(i).

The process of the invention can be utilized in both forward auctions and reverse auctions. The present invention also includes a reverse auction that is opposite to the (forward) auction described above. That is, in a reverse auction, buyers are those who put up the request for the good/service and receive offers, and sellers are those who place the offers and bid, and the one with the lowest offer among the approved sellers, will be the winner.

In one embodiment, the online bidding method (reverse auction) may be implemented by using a computerized reverse auction system, and include the following steps:
a. operating a buyer's user interface to create a listing for a purchase or rent of goods or services, the listing to include a discounted price set by the buyer or a request for a discounted price from a first seller, wherein the discounted price is conditioned by:
   i. an obligation by the first seller to undergo a reverse auction for the listed goods or services,
   ii. an obligation by the buyer to purchase or rent the listed goods or services from the lowest bidder at the auction and at the lowest price,
b. operating at least one seller's user interface to present the listing for the purchase or rent of goods or services of step (a),
c. in response to at least the first seller accepting the discounted price for the listed goods or services through the seller's user interface, operate the computerized reverse auction system to automatically initiate an automated reverse auction with the first seller and other sellers if present, or to complete the transaction with the first seller at the discounted price if no other sellers are present,
d. operating the computerized reverse auction system to automatically complete the reverse auction to determine the lowest bidder and the lowest price, and
e. operating the computerized reverse auction system to automatically complete the transaction after the reverse auction of step (d) is complete to purchase or rent the listed goods or services from the lowest bidder and at the lowest price.

The advantage of the novel bidding method is that upon at least the first seller accepting the discounted price, the transaction is guaranteed to be completed at least at the discounted price or lower, thereby reducing the number of unfulfilled listings.

In accordance with exemplary embodiments, the owner/bidder may be able to set multiple (one or more) prices with different auction durations in which the prices and the auction durations are inversely proportional (in a forward auction) or may be able to set multiple prices and the auction durations are directly proportional (in a reverse auction).

Also, in accordance with exemplary embodiments, listings and/or bidding participants can be selected or pre-approved by the owner, private or public etc. The word owner or bidder may refer to any of the person/entity itself, his/her/its representative, designated agents, etc.

When referred to herein, the meaning of the term “auction” may include English auction, first-price sealed-bid auction, second-price sealed-bid auction (Vickrey auction), etc.

In accordance with exemplary embodiments, the method of payment for deposits and closing are arbitrary: e.g., credit/debit card, money transfer, demand draft, certified check, cash, bank guarantee, surety bond, cryptocurrency, etc.

In accordance with an exemplary embodiment and as stated earlier, the auction scheme detailed may be applied to reverse auctions as well as forward auctions. In either a forward or a reverse auction, the bid can be calculated as the weighted average of the price offered by the bidder and the qualification score of the bidder by the owner. (e.g., the owner has approved two bidders X & Y, and he gives X a technical qualification score of 70/100, and Y a score of 90/100, if the owner puts a weight of 60% on qualification and 40% on price, then if X bids $100, and Y bids $80, the resulting bid value of X would be=(70*0.6+100*0.4)=82, and bid value of Y=(90*0.6+80*0.4)=86, thus Y wins).

The automated auction process of the present invention offers numerous advantages to sellers, buyers, and intermediaries, greatly enhancing the overall auction experience for all involved parties. These benefits include:
Maximized Returns for Sellers
   Sellers can ensure they receive the best possible offer from serious buyers by creating an opportunity for competitive bidding. This quick auction allows sellers to attract higher bids for items that may have already sold at a lower price;
   The process guarantees that only genuinely interested and financially capable buyers participate, thereby reducing the likelihood of deal cancellations and increasing the reliability of sales.
Increased Appeal to Serious Buyers
   Buyers who can afford to pay more are encouraged to participate, knowing that they have a fair chance to outbid others for an item that may have been otherwise already sold at a seemingly discounted rate;
   Measures to prevent shill bidding, such as requiring verified deposits before bidding and penalizing bid retractions, provide a secure and trustworthy environment. This increases buyer confidence and willingness to participate in the auction process.
Enhanced Efficiency for Intermediaries and Online Platform Owners
   Intermediaries benefit from a more streamlined and automated process, reducing the need for manual oversight and intervention;
   The improved system can handle a higher volume of transactions more effectively, leading to increased revenue opportunities through transaction fees and commissions.
Fairer Competition and Transparency
   The automated auction process of the invention ensures transparent bidding, where all participants are aware of the highest bid and have equal opportunities to place their offers;
   Enhanced transparency helps build trust in the auction platform, attracting more users and fostering a loyal customer base.
Reduction in Unsold Items and Relisting Costs
   By facilitating a quick and competitive bidding process, the likelihood of items remaining unsold is significantly reduced;
   Sellers save on relisting fees and time, as items are more likely to be sold during the initial auction period.
Mitigation of Shill Bidding
   The requirement for bidders to make verified deposits acts as a deterrent to shill bidding, as participants face the risk of losing their deposits if they retract their bids;
   This measure ensures a fair and competitive bidding environment, where prices are determined by genuine market interest rather than manipulative practices.
Improved User Experience
   The automated process offers a seamless and efficient experience for both sellers and buyers, reducing the complexities and frustrations associated with traditional auction methods;
   Users can enjoy a more engaging and dynamic auction process, leading to higher satisfaction and repeat participation.

By implementing these advanced features, the automated auction process of the invention creates a more favorable environment for all parties involved, promoting higher engagement, trust, and successful transactions.

While an improved bidding process has been described in detail, it is to be understood that numerous changes and modifications can be made to embodiments of the present invention without departing from the scope of the invention.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components unless the context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their

scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations or two or more recitations). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, Band C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, Band C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise.

For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently.

Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. An online bidding method implemented by using a computerized auction system, the bidding method comprises steps as follows:
a. operating a seller's user interface to create a listing for a sale or rent of goods or services, the listing to include a discounted price set by the seller or a request for a discounted price from a first buyer, wherein the discounted price is conditioned by:
i. an obligation by the first buyer to undergo an auction for the listed goods or services,
ii. an obligation by the seller to sell or rent the listed goods or services to a highest bidder at the auction and at the highest price or to sell or rent thereof to the first buyer and at the discounted price if no other buyers are present,
b. operating at least one buyer's user interface to present the listing for the sale or rent of goods or services of step (a),
c. in response to at least the first buyer accepting the discounted price for the listed goods or services through the buyer's user interface, operate the computerized auction system to automatically initiate an automated auction with the first buyer and other buyers if present,
d. operating the computerized auction system to automatically complete the auction to determine the highest bidder and the highest price, and
e. operating the computerized auction system to automatically complete the transaction after the auction of step (d) is complete to sell or rent the listed goods or services to the highest bidder and at the highest price,
wherein upon at least the first buyer accepting the discounted price, the transaction is guaranteed to be completed at least at the discounted price or higher.

2. The bidding method, as in claim 1, wherein step (a) further comprising a step of providing by the seller a “buy or rent now” price, wherein the “buy or rent now” price is higher than the discounted price, and wherein the method further comprising a step (f) of operating the computerized auction system to automatically complete the transaction immediately upon the first buyer accepting the “buy or rent now” price without the auction.

3. The bidding method, as in claim 1, wherein step (b) further comprising a step of operating the computerized auction system to automatically accept a deposit from each buyer prior to initiating the auction and/or including the buyer into the auction for the listed goods and services.

4. The bidding method, as in claim 3, further including a step of operating the computerized auction system to automatically refund the deposit to all buyers other than the first buyer or the highest bidder.

5. The bidding method, as in claim 1, further comprising a step of defining the discounted price once agreed to by both the first buyer and the seller.

6. The bidding method, as in claim 5, wherein the step of defining the discounted price further comprising a step of the first buyer proposing a first discounted price, followed by a step of the seller agreeing thereto or counteroffering a second discounted price, wherein the second discounted price is higher than the first discounted price.

7. The bidding method, as in claim 1, wherein discounted price comprises a plurality of discounted prices corresponding to a plurality of auction durations, wherein the discounted prices of the plurality of discounted prices are progressively reduced as the corresponding auction durations increase.

8. The bidding method, as in claim 1, wherein the seller interface is configured to accept the listing of step (a) and cause the listing to be available to at least the first buyer only after the seller confirms irrevocable acceptance of the obligation of the seller specified in step (a)(ii).

9. The bidding method, as in claim 8, wherein the buyer interface is configured to accept the first buyer's acceptance of the discounted price for the listed goods or services in step (c) only after the buyer confirms irrevocable acceptance of the obligation of the buyer specified in step (a)(i).

10. The bidding method, as in claim 1, wherein the computerized auction system is operatively connected to the buyer interface and the seller interface via the Internet, thereby facilitating completion of steps (a) through (e) without a need for the buyer and the seller to be in one location.

11. An online bidding method implemented by using a computerized reverse auction system, the bidding method comprises steps as follows:
a. operating a buyer's user interface to create a listing for a purchase or rent of goods or services, the listing to include a discounted price set by the buyer or a request for a discounted price from a first seller, wherein the discounted price is conditioned by:
i. an obligation by the first seller to undergo a reverse auction for the listed goods or services,
ii. an obligation by the buyer to purchase or rent the listed goods or services from the lowest bidder at the auction and at the lowest price
b. operating at least one seller's user interface to present the listing for the purchase or rent of goods or services of step (a),
c. in response to at least the first seller accepting the discounted price for the listed goods or services through the seller's user interface, operate the computerized reverse auction system to automatically initiate an automated reverse auction with the first seller and other sellers if present, or to complete the transaction with the first seller at the discounted price if no other sellers are present,
d. operating the computerized reverse auction system to automatically complete the reverse auction to determine the lowest bidder and the lowest price, and
e. operating the computerized reverse auction system to automatically complete the transaction after the reverse auction of step (d) is complete to purchase or rent the listed goods or services from the lowest bidder and at the lowest price,
wherein upon at least the first seller accepting the discounted price, the transaction is guaranteed to be completed at least at the discounted price or lower.
